(19) United States
(12) Patent Application Publication
(10) Pub. No.: US 2023/0130506 A1
(43) Pub. Date: Apr. 27, 2023

(54) BEVERAGE CONTAINER

(71) Applicant: HEX20, Inc., Ann Arbor, MI (US)

(72) Inventors: Noah Kaplan, Ann Arbor, MI (US); Michael Martin, Ann Arbor, MI (US)

(73) Assignee: HEX20, Inc.

(21) Appl. No.: 17/511,438

(22) Filed: Oct. 26, 2021

(51) Int. Cl. B65D 17/00; B65D 17/28; B65D 21/02

(52) U.S. Cl. CPC B65D 17/04; B65D 17/4012; B65D 21/0213

(57) ABSTRACT

A container for storing liquids includes a top, a bottom, and a body. The top is a first recessed surface surrounded by a raised edge, the first recessed surface having a secondary recessed surface with a pull tab configured to engage a punchout opening to open the container. The bottom is a second recessed surface surrounded by a second raised edge, and the second raised edge configured to fit inside the first raised edge of the top. The body is a polygon with at least four sides extending vertically from the top to the bottom and at least the body is comprised of biobased polymer materials.

### TECHNICAL FIELD

This disclosure relates generally to a container for holding liquids and, more particularly, to an apparatus for holding liquids that is unique in shape to reduce wasted space in packaging and is made of biobased and biodegradable-compostable polymer materials.

### BACKGROUND

Current liquid containers, particularly those for holding beverages, may be cylindrical in shape and made of polyethylene terephthalate (PET) or other non-biodegradable plastics. Liquid containers may be purchased as a single container or as multi-container pack and are often found on supermarket shelves for purchase by a consumer. Supermarket distributors can charge a slotting fee to manufacturers to place their product on shelves in stores. Manufacturers then compete with the varying products on supermarket shelves to stand out to consumers.

Manufacturers may also be limited in the shelf space provided for a particular product. Current cylindrical containers are unable to tessellate, creating holes of wasted space between containers. Wasted space reduces efficiency in shipping and storing products, resulting in paid for space going unused.

PET is widely used for packing materials, particularly for storing liquids and beverages. Most commercial methods produce PET with petroleum derived raw materials. The cost of PET is closely tied to that of petroleum, leading to high and varying prices to produce PET. The carbon content derived from petroleum and other fossil fuels results in high greenhouse emissions during the production of PET. Environmental regulations are becoming more rigorous, and the prevalence of petroleum resources are becoming more scarce.

Therefore, a need exists for improved efficient design and environmentally conscious manufacturing of liquid and or semi-liquid containers. A bio-based material would satisfy consumers' increasing demand for environmentally friendly products and a unique efficient design would make the environmentally friendly product stand out to consumers, while saving space and money for manufacturers and supermarkets.

### BRIEF DESCRIPTION

The disclosure is directed toward a recyclable container for storing liquids with an efficient design and environmentally conscious composition.

According to one aspect, a container for storing liquids includes a top, a bottom, and a body. The top has a first hexagonal recessed surface surrounded by a first raised edge with six equal sides, the first hexagonal recessed surface includes a secondary recessed surface having a hexagonal pull tab, the hexagonal pull tab is configured to engage an oval punchout opening to open the container. The bottom has a second hexagonal recessed surface surrounded by a second raised edge with six equal sides, the second raised edge is configured to fit inside the first raised edge of the top. The body has six sides extending vertically from the top to the bottom, and at least the body is comprised of biobased polymer materials made without the use of fossil fuels.

According to another aspect, a container for storing liquids includes a top, a bottom, and a body. The top is a first quadrilateral recessed surface, the first quadrilateral recessed surface having two rounded corners and two sharp corners, the first quadrilateral recessed surface is surrounded by a first raised edge, the first quadrilateral recessed surface includes a secondary recessed surface having a hexagonal pull tab, and the hexagonal pull tab is configured to engage an oval punchout opening to open the container. The bottom is a second quadrilateral recessed surface, the second quadrilateral recessed surface having two rounded corners and two sharp corners, the second quadrilateral recessed surface having a second raised edge, and the second raised edge configured to fit inside the first raised edge of the top. The body has four sides extending vertically from the top to the bottom, the body having two rounded edges and two sharp edges, and at least the body is comprised of biobased polymer materials made without the use of fossil fuels.

According to another aspect, a container for storing liquids includes a top, a bottom, and a body. The top is a first recessed surface surrounded by a raised edge, the first recessed surface having a secondary recessed surface with a pull tab configured to engage a punchout opening to open the container. The bottom is a second recessed surface surrounded by a second raised edge, and the second raised edge configured to fit inside the first raised edge of the top. The body is a polygon with at least four sides extending vertically from the top to the bottom and at least the body is comprised of biobased polymer materials.

Various other features and advantages will be made apparent from the following detailed description and the drawings. For example, it will be apparent by the disclosure that the container disclosed could be made of various compositions including with fillers or manufacturing agents, or it could be made of varying designs and group configurations to meet manufacturers needs.

### BRIEF DESCRIPTION OF THE DRAWINGS

FIG. 1A illustrates a front view of the hex shaped container;

FIG. 1B illustrates a top view of the hex shaped container;

FIG. 1C illustrates a bottom view of the hex shaped container;

FIG. 1D illustrates a perspective view of the hex shaped container;

FIG. 2A illustrates a perspective view of the hex shaped containers nested in a triangle 6-pack;

FIG. 2B illustrates a top view of the hex shaped containers nested in a triangle 6-pack;

FIG. 2C illustrates a perspective view of the hex shaped containers nested in a triangle 6-pack and stacked on top of one another;

FIG. 2D illustrates a top view of a plurality of triangle 6-pack configurations nested together;

FIG. 3A illustrates a perspective view of the hex shaped containers nested in a rhombus 6-pack;

FIG. 3B illustrates a top view of the hex shaped containers nested in a rhombus 6-pack;

FIG. 3C illustrates a perspective view of the hex shaped containers nested in a rhombus 6-pack and stacked on top of one another;

FIG. 4A illustrates a perspective view of the hex shaped containers nested in a hive 7-pack;

FIG. 4B illustrates a top view of the hex shaped containers nested in a hive 7-pack;

FIG. 4C illustrates a perspective view of the hex shaped containers nested in a hive 7-pack and stacked on top of one another;

FIG. 5A illustrates a front view of the leaf shaped container;

FIG. 5B illustrates a top view of the leaf shaped container;

FIG. 5C illustrates a bottom view of the leaf shaped container;

FIG. 5D illustrates a perspective view of the leaf shaped container;

FIG. 6A illustrates a perspective view of the leaf shaped containers nested in a 12-pack;

FIG. 6B illustrates a top view of the leaf shaped containers nested in a 12-pack;

FIG. 6C illustrates a perspective view of the leaf shaped containers nested in a 12-pack and stacked on top of one another; and

FIG. 6D illustrates a top view of a plurality of leaf shaped containers in 12-pack configurations that are nested together.

### DETAILED DESCRIPTION

The method and system of the disclosed examples are described with respect to containers for liquid, and more particularly, to an apparatus for holding liquids that is unique in shape to reduce wasted space in packaging and is made of biobased and biodegradable-compostable polymer materials.

The present disclosure improves shipping and stacking of containers that store liquids. The containers reduce wasted space in packaging, improve a consumer's ability to grip the containers, help manufacturer's ability to meet target environmental goals, and clearly identify a product based on meeting certain environmental metrics based on the unique shape of the containers.

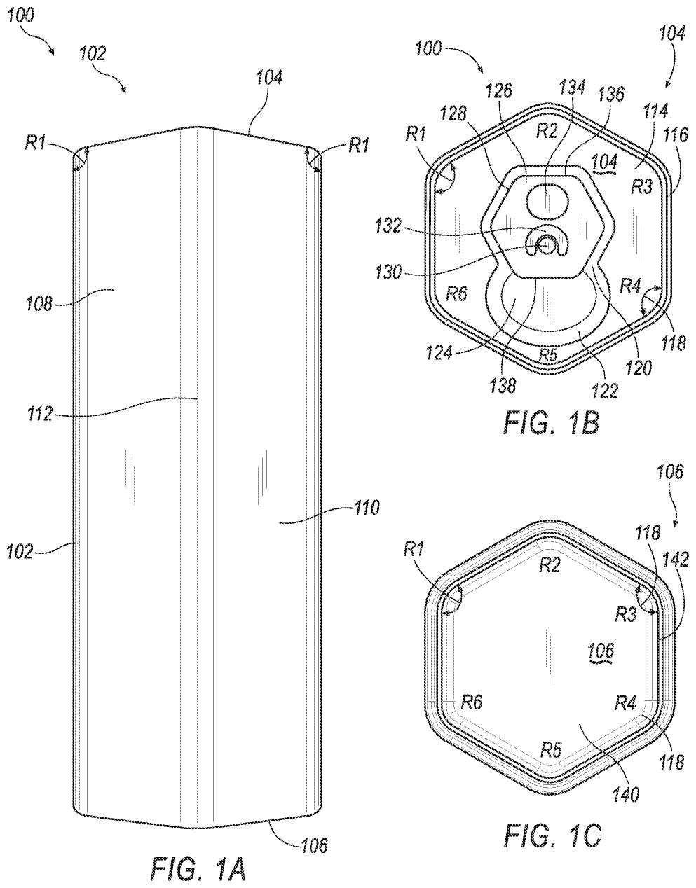

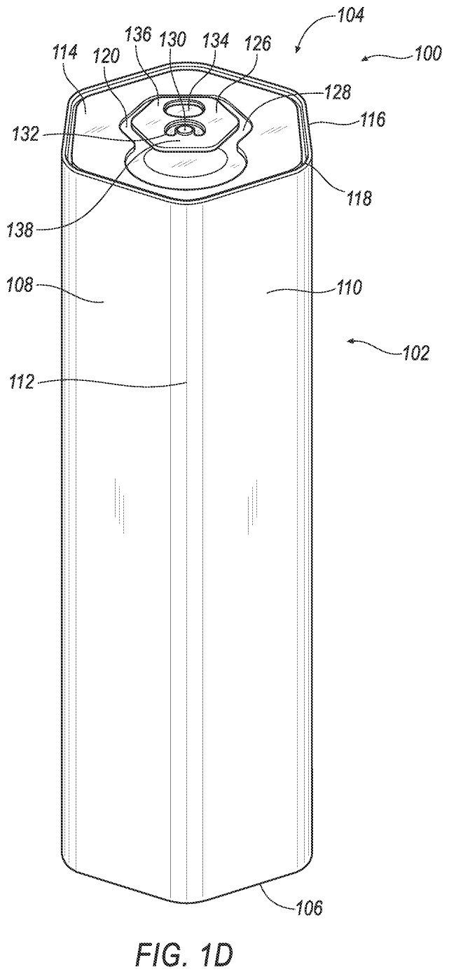

Referring to FIGS. 1A-1D, a container 100 for storing liquids is disclosed including a body 102, a top 104, and a bottom 106. Container 100 has a hexagon shaped configuration that begins at top 104 and extends vertically through container 100 to bottom 106. FIG. 1A illustrates a front view of the hexagon shaped container 100. A first wall 108 and a second wall 110 run vertically from top 104 of container 100 to bottom 106 of container 100. First wall 108 and second wall 110 converge along a rounded bent seam 112 that runs the vertical length of container 100. Bent seam 112 is at approximately a 120-degree angle and has a corner radius R1 of approximately 0.400″. Bent seam 112 extends from the top to the bottom through the body with a corner radius equal throughout the body. Body 102 may be of any height, but preferably about 6″ in height for storing liquid beverages. Width of container 100 is approximately forty percent the length of the body 102.

FIG. 1B illustrates a top view of the hexagon shaped container 100. Top 104 of container 100 contains a first recessed surface 114 that has a hexagon shape. A raised hexagonal shaped edge 116 surrounds the perimeter of the first recessed surface 114 and is comprised of six raised continuous edges and six raised continuous angled corners (R1, R2, R3, R4, R5 and R6). Each of the six angled corners 118 are equal to each other and are approximately 120 degrees with a corner radius R1 of approximately 0.400″. R1, R2, R3, R4, R5 and R6 are all equal angels. First recessed surface 114 includes a second recessed surface 120. Second recessed surface 120 includes a hexagon shaped portion 128 and an oval shaped portion 122 that connect with one another. Oval portion 122 of second recessed surface 120 includes an oval punch out opening 124. A hexagon shaped pull tab 126 is located on top of the second recessed surface 120 near the approximate center CL of the hexagon portion 128 of second recessed surface 120. Pull tab 126 is attached to second recessed surface 120 via a circular pin 130. Surrounding circular pin 130 is a horseshoe opening 132 within the pull tab 126 pointing towards the oval portion 122 of second recessed surface 120. Pull tab 126 further has an oval shaped opening 134 positioned near the curved portion of horseshoe opening 132.

Traditional pull tabs are made of aluminum but pull tab 126 may be made of a variety of materials, including a biobased polymer. Illustrated in FIG. 1B is a hexagon shaped pull tab 126, but any geometric configuration may be used. Pull tab 126 may be of varying sizes, but approximately forty percent the width of top 104 of container 100. Pull tab 126 is configured to be drawn up in a vertical direction by a consumer on a first side 136. Oval opening 134 on pull tab 126 is configured to be used by consumer to grip pull tab 126 with finger to assist in drawing tab up. Pull tab 126 is configured to move on a hinge line at horseshoe opening 132 such that when pull tab 126 is pulled upward on a first side 136, pull tab 126 bends and a second side 138 opposite first side 136 is pushed down in a vertical direction. Horseshoe opening 132 is configured to bend without breaking when pull tab 126 is drawn up. When first side 136 is drawn up, second side 138 pushes down on oval punch out opening 124 on second recessed surface 120 of top 104. Punch out opening 124 is illustrated as an oval, but any shape opening may be used. When second side 138 of pull tab 126 pushes down on punch out opening 124, punch out opening 124 will perforate, creating an orifice in second recessed surface 120. Orifice allows liquid to exit container 100 to be used or consumed by consumer.

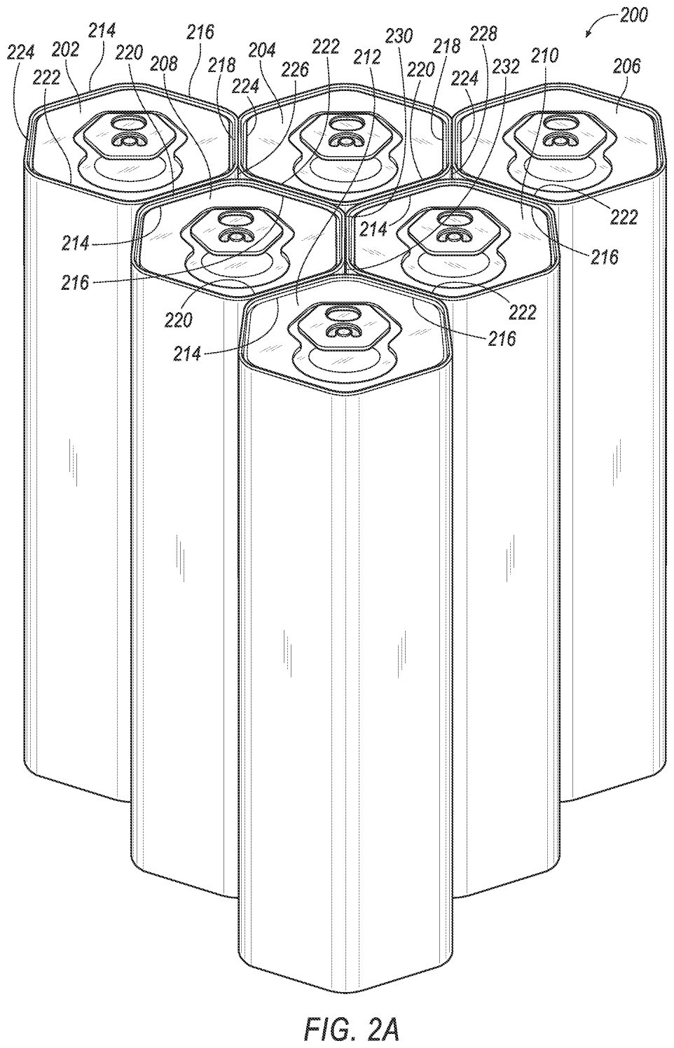

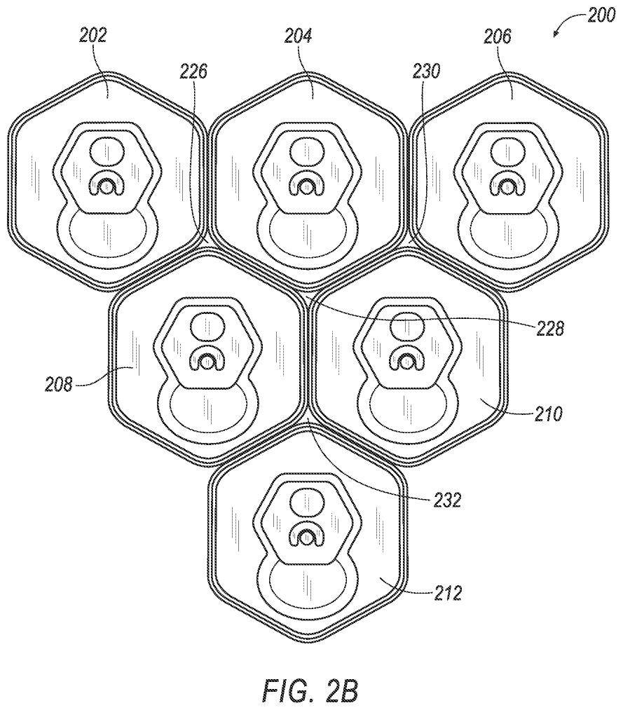

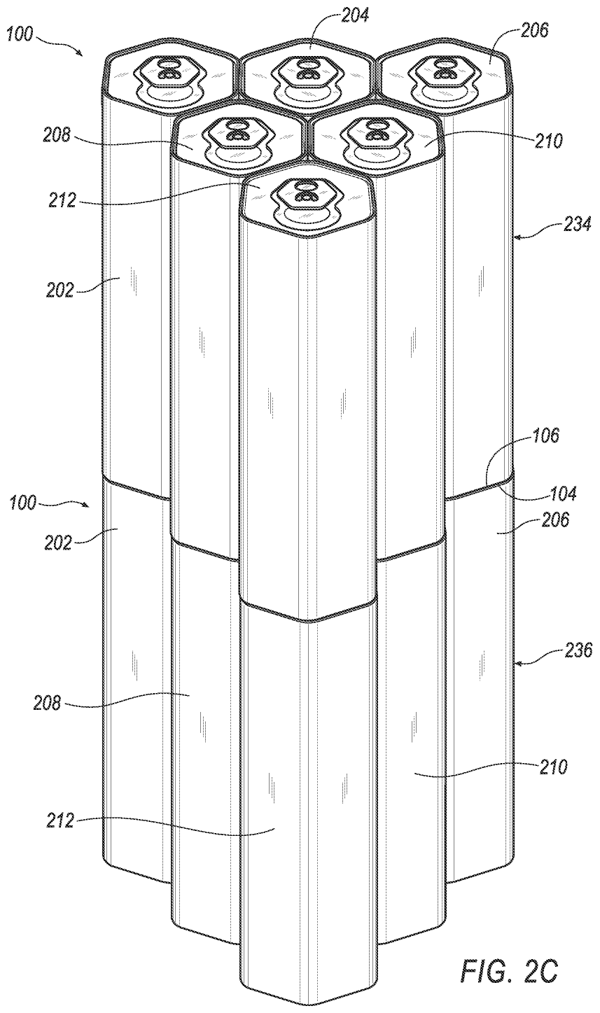

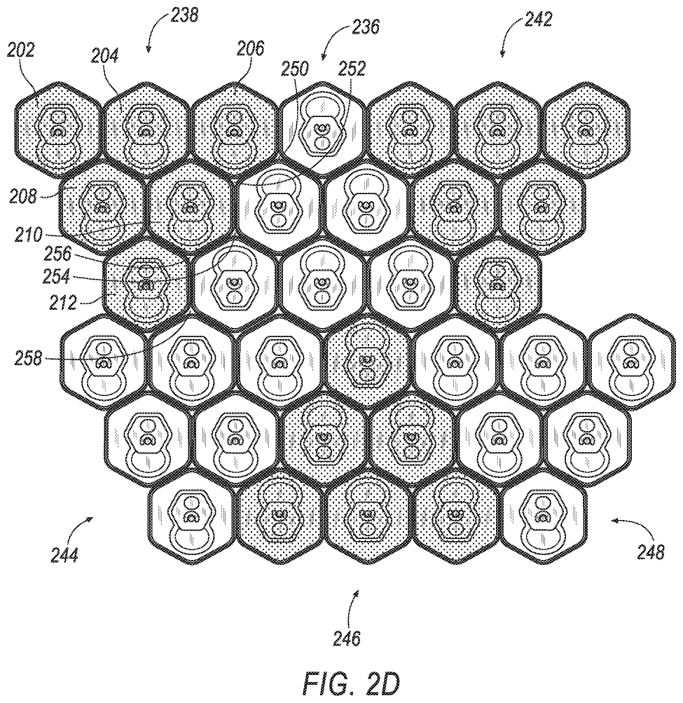

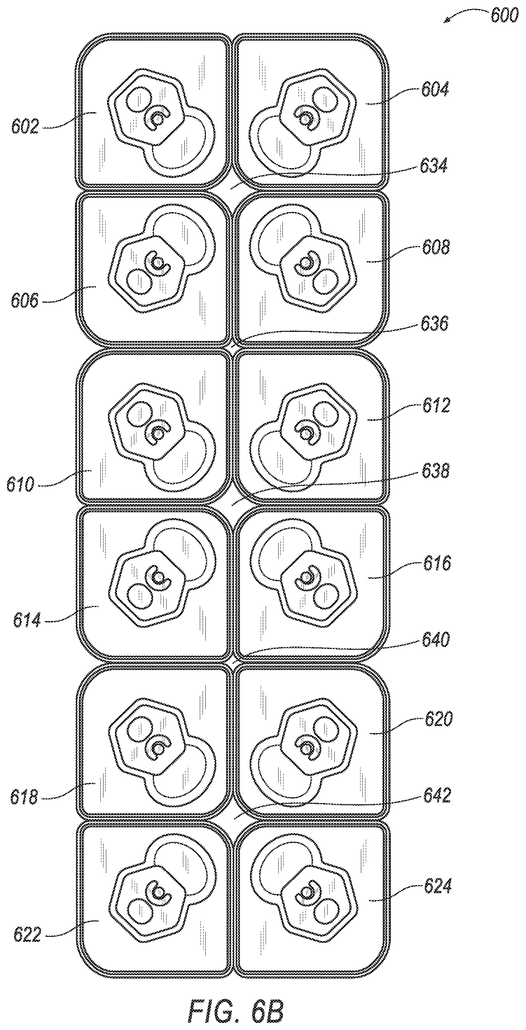

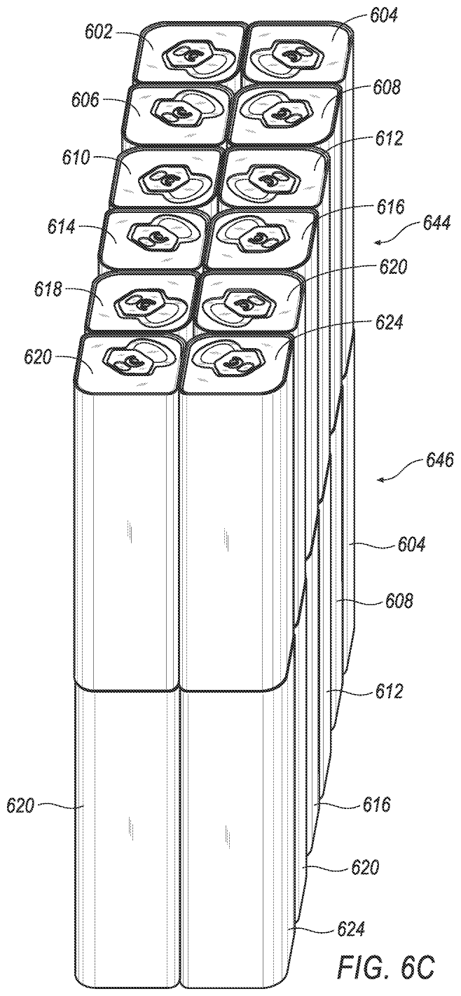

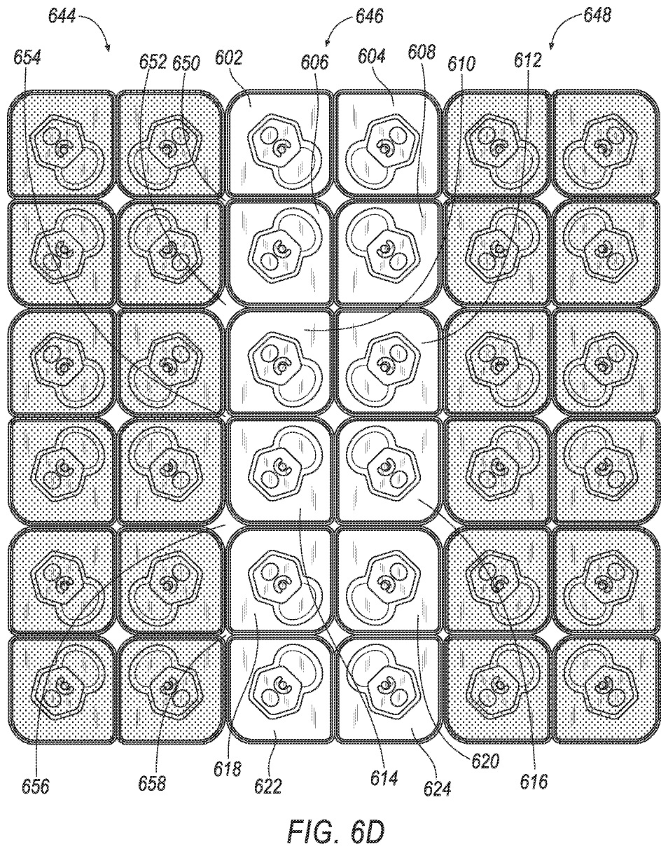

FIG. 1C illustrates a bottom view of hexagon shaped container 100. Bottom 106 includes six edges and six angled corners (R1-R6). Each of the six angled corners 118 are equal to each other and are approximately 120 degrees creating a hexagon shape, with a corner radius R1 of approximately 0.400″. Bottom 106 includes a hexagon shaped third recessed surface 140 inside a raised bottom edge 142. Raised bottom edge 142 extends from bottom 106 of container 100 a length approximately two percent of the length of body 102 of container 100. Bottom edge 142 is configured such that if placed on top of a second hexagon shaped container 100, bottom edge 142 would fit inside edge 116 of container 100 top 104. Raised edge 116 of top 104 second container 100 would create an outer hexagonal edge and bottom edge 142 of first container 100 would create an inner hexagonal edge such that the two containers would be nestable relative to one another and the bottom edge of the first container is receivable within recessed surface 114 of top 104 of second container. Such configuration allows for a plurality of containers 100 to stack with ease of fit. Overlap on the surfaces creates a sturdier interaction between stacked containers. The sturdier nestable configuration allows several heights of containers to be stacked (see FIGS. 2C and 6C).

FIG. 1D illustrates a perspective view of hexagon shaped container 100. The top 104, the bottom 106, and the body 102 are of a hexagonal geometric configuration such that a plurality of containers may be configured in a group where three containers meet at a vertex, and the plurality of containers creates a tessellation with an area of wasted space reduced between the plurality of containers. Hexagon shaped containers are capable of being nested in a group during at least shipping, storing, and selling. Hexagon shaped containers allow containers to be grouped in at least a triangular pack of six containers, a rhombus pack of six containers, or a hive pack of seven containers. Containers are configured such that wasted space between containers in a group is reduced. Reduction of wasted space is beneficial as more space is left either during shipping or storing for more containers. Shelf space at a grocery store is expensive and current container packaging is ineffective in that wasted space is abundant in packaging. Nesting of hexagonal containers reduces wasted space, allowing more containers to be placed on a shelf in a more effective means.

FIG. 2A illustrates six hexagon shaped containers nested in a triangular configuration from a perspective view. A first container 202 and a second container 204 are placed such that a third edge 218 of the first container 202 and a sixth edge 224 of the second container 204 are placed next to each other running parallel. The third edge 218 and the sixth edge 224 are opposite each other on a container 200. A third container 206 is placed such that a sixth edge 224 of the third container 206 is placed next to the third edge 218 of the second container 204. First container 202, second container 204, and third container 206 are placed next to each other such that they create a line of containers. A fourth container 208 is placed such that a first edge 214 of the fourth container 208 is next to the fourth edge 220 of the first container 202 and the second edge 216 of the fourth container 208 is next to the fifth edge 222 of the second container 204. The first container 202, second container 204, and fourth container 208 converge at a corner, creating a first white space 226 of wasted area between containers. A fifth container 210 is placed such that a first edge 214 of fifth container 210 is placed along fourth edge 220 of second container 204 and a second edge 216 of fifth container 210 is placed along fifth edge 222 of third container 206. Second container 204, fourth container 208, and fifth container 210 converge along a corner, creating a second white space 230 of wasted area between containers. Second container 204, third container 206, and fifth container 210 converge along a corner, creating a third white space 228 of wasted area between containers. A sixth container 212 is placed such that the first edge 214 of sixth container 212 is placed next to fourth edge 220 of fourth container 208 and second edge 216 of sixth container 212 is placed next to fifth edge 222 of fifth container 210. Fourth container 208, fifth container 210, and sixth container 212 converge along a corner, created a fourth white space 232 of wasted area between containers.

FIG. 2B illustrates a top view of six hexagon shaped containers nested in a triangular configuration. The hexagon shape allows containers to be grouped in such a way to reduce space between the corners of containers compared to traditional shapes and configurations. First container 202, second container 204, and fourth container 208 converge along a corner at first white space 226. Second container 204, fourth container 208, and fifth container 210 converge along a corner at second white space 228. Second container 204, third container 206 and fifth container 210 converge along a corner at third white space 230. Fourth container 208, fifth container 210, and sixth container 212 converge along a corner at fourth white space 232.

As shown in FIG. 2B, each container contains six linear sides and six angled corners, creating a smooth and continuous hexagon shape. Each angled corner is approximately 120 degrees. The containers are arranged in triangular configuration 200 such that three containers converge at a vertex. The convergence of three containers with a 120-degree corner in each container allows containers to tessellate and nest closely together. Three 120-degree corners fit in a 360-degree space with minimal waste area in between the corners of each container. A plurality of containers can be arranged in triangular configuration 200 creating a tessellation. Reduction in wasted space between the containers allow the nested configuration of containers to take up less shelf space, such as in locations where space is limited like on a shelf at a grocery store or while in shipping.

FIG. 2C illustrates a first triangular six pack 234 of containers 100 stacked on top of a second triangular six pack 236 of containers 100. First pack 234 of containers is configured such that the bottom 106 of the six containers are placed on the top 104 of the six containers of second pack 236. As illustrated in FIGS. 1B and 1C, bottom 106 of container 100 is configured with an edge 142 that fits inside edge 116 of top 104 of container 100 to facilitate a nestable relationship. Bottom edge 142 of container from first pack 234 is nestable in that it is receivable with top edge 116 of container from second pack 236. Top edge 116 of second container creates an outer hexagonal ring and bottom edge 142 of first container create an inner hexagonal ring. The first container and the second container converge in such a way that the two containers create a nearly flat surface that is sturdy and improves a stacking structure. Containers are nestable inside the edges 116, 142 such that when stacked, two containers create a smooth and continuous appearance with no gaps of space between the stacked containers. Nestability of containers create a sturdier stacking structure during shipping and storing of containers.

Illustrated in FIG. 2C, a first triangular pack 234 of containers and a second triangular pack 236 of containers are stacked such that a first container 202 of first triangular pack 234 is placed on top of a first container 202 of second triangular pack 236. Second container 204 of first triangular pack 234 is placed on top of second container 204 of second triangular pack 236. Third container 206 of first triangular pack 234 is placed on top of third container 206 of second triangular pack 236. Fourth container 208 of first triangular pack 234 is placed on top of fourth container 208 of second triangular pack 236. Fifth container 210 of first triangular pack 234 is placed on top of fifth container 210 of second triangular pack 236. Sixth container 212 of first triangular pack 234 is placed on top of sixth container 212 of second triangular pack 236.

In addition to stacked configurations, the hexagon shaped containers allow nested configurations to sit adjacent to each other in such ways to reduce wasted space between nested configurations and create a tessellation. Illustrated in FIG. 2D are six triangular six-packs of containers placed adjacent to each other. A second pack 240 may be placed in the opposite direction of a first pack 238 such that the sixth container 212 of the first pack 238 is placed adjacent to the third container 206 of the second pack 240. The sixth container 212 of the second pack 240 is located next to the third container 206 of the first pack 238. A third pack 206 may be placed in the original facing direction, such that the first container 202 of the third pack 242 is placed next to the sixth container 212 of the second pack 240 and the sixth container 212 of the third pack 242 is placed next to the first container 202 of the second pack 236. The first pack 238, second pack 236, and third pack 242 are configured in a linear manner such that they create three rows of containers.

Containers converge along corners where three containers meet. Three containers each include a 120-degree corner, converging along a 360-degree space which minimizes wasted area in white spaces. For instance, and as illustrated in FIG. 2D, white spaces are found between first pack 238 and second pack 236. White space 250, 252, 254, 256 and 258 are created by the convergence of two containers 236 and 238.

Illustrated in FIG. 2D is a fourth pack 244, a fifth pack 246, and a sixth pack 248 configured in a linear manner such that they create three rows of containers in front of the first pack 238, second pack 236, and third pack 242. A fourth pack 244 may be placed in a front facing direction such that the sixth container 212 of the first pack 238 converges with the first container 202 and second container 204 of the fourth pack 244 to create a white space. The fifth pack 246 is placed such that it is facing the opposite direction where the sixth container 212 of the fifth pack 246 is placed adjacent to the third container 206 of the fourth pack 244. The sixth pack 248 is placed in the original forward-facing direction with the first container 202 of the sixth pack 248 placed next to the sixth container 212 of the fifth pack 246.

As illustrated amongst the plurality of packs in FIG. 2D, the area of wasted space illustrated as white spaces between containers is minimal. The hexagon shape of the containers creates a tessellation when a plurality of containers is grouped together. White space between grouped packs is reduced just as white space between individual containers is reduced. The packs tesselate further, creating less wasted space than traditional container packs. Triangular packs of hexagon shaped containers reduce wasted space on shelves and in shipping, allowing for more efficient use of space which is often limited and expensive for manufacturers to use.

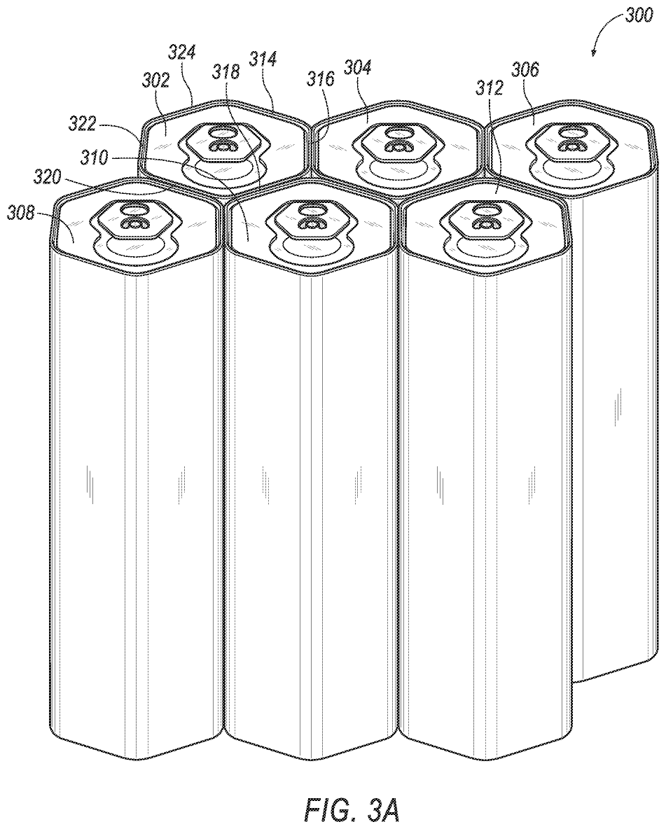

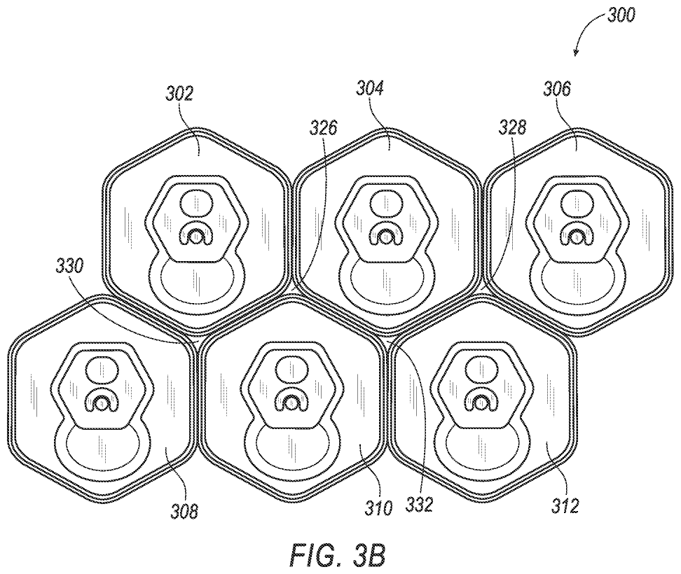

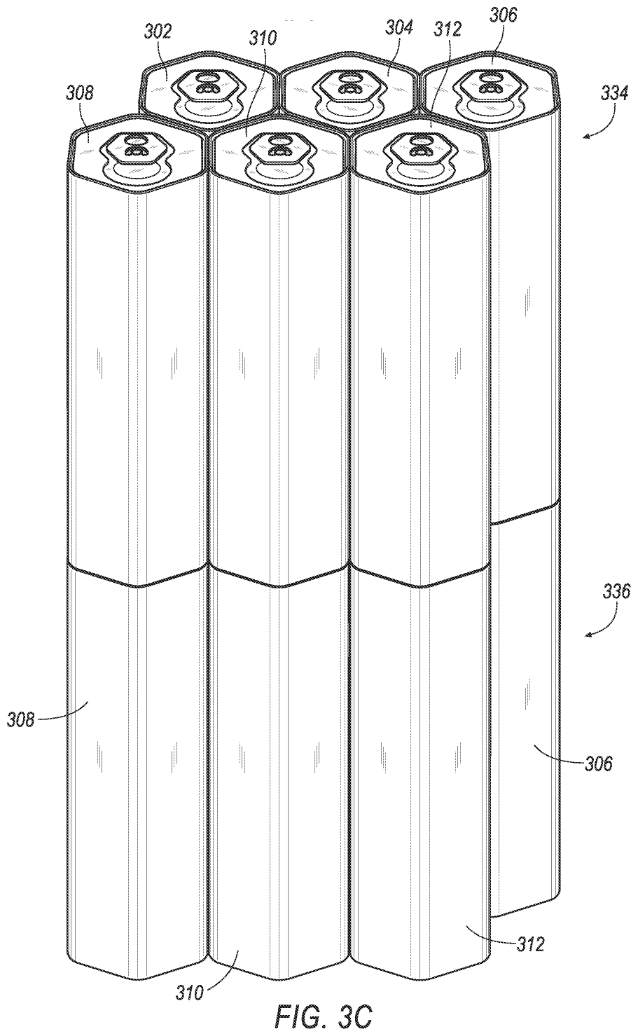

FIG. 3A illustrates hexagon shaped containers in an alternative six-pack configuration shaped as a rhombus from a perspective view. In a rhombus six pack configuration 300, a third edge 318 of first container 302 is placed next to the sixth edge 324 of second container 304 such that third edge 318 of first container 302 and sixth edge 324 of second container 304 are parallel to each other. A third container 306 is placed such that sixth edge 324 of third container 306 is placed next to third edge 318 of second container 304. A fourth container 308 is placed such that second edge 316 of fourth container 308 is placed next to fifth edge 322 of first container 302. A fifth container 310 is placed such that first edge 314 of fifth container 310 is placed next to fourth edge 320 of first container 302, second edge 316 of fifth container 310 is placed next to fifth edge 322 of second container 304, and sixth edge 324 of fifth container 310 is placed next to third edge 318 of fourth container 308. A sixth container 312 is placed such that first edge 314 of sixth container 312 is placed next to fourth edge 320 of second container 304, second edge 316 is placed next to fifth edge 322 of third container 306, and sixth edge 324 of sixth container 312 is placed next to third edge 318 of fifth container 310.

FIG. 3B illustrates hexagon shaped containers in a six-pack configuration 300 shaped as a rhombus from a top view. As illustrated in FIG. 3A and more clearly shown in FIG. 3B, first container 302, second container 304, and fifth container 310 converge along a corner at first white space 326. First container 302, second container 304, and fifth container 310 each contain an approximately 120-degree corner, each converging at a vertex in a 360-degree area at first white space 326. The wasted area between first container 302, second container 304, and fifth container 310 at first white space 326 is reduced due to the angled corners. The hexagon shaped containers tessellate when grouped together. Second container 304, third container 306, and sixth container 312 converge at a corner, creating second white space 328 of wasted area between containers. First container 302, fourth container 308, and fifth container 310 converge at a corner, creating third white space 330 of wasted area between containers. Second container 304, fifth container 310, and sixth container 312 converge at a corner, creating fourth white space 332 of wasted area between containers. First white space 326, second white space 328, third white space 330, and fourth white space 332 are essentially equal, are triangle in shape, and are minimal in size due to tessellation of hexagon shaped containers.

FIG. 3C illustrates a perspective view of a rhombus shaped six-packs stacked on each other. A first pack 334 of hexagon shaped containers nested in a six-pack configuration as a rhombus is placed on a second pack 336 of hexagon shaped containers nested in a six-pack configuration as a rhombus. A first container 302 of first pack 334 is placed on top of a first container 302 from second pack 336. A second container 304 of first pack 334 is placed on top of a second container 304 from second pack 336. A third container 306 of first pack 334 is placed on top of a third container 306 from second pack 336. A fourth container 308 of first pack 334 is placed on top of a fourth container 308 from second pack 336. A fifth container 310 of first pack 334 is placed on top of a fifth container 310 from second pack 336. A sixth container 312 of first pack 334 is placed on top of a sixth container 312 from second pack 336. As illustrated in FIGS. 1B and 1C, the containers stack on top of each other such that hexagon edge 142 from the bottom 106 of a container from first pack 334 fits inside hexagon edge 116 from the top 104 of a container from the bottom pack 336. Container from first pack 334 is nestable with container from second pack 336 in that edge from bottom 106 is nestable within edge 116 from top 104. Convergence of containers on top of each other creates a near flat, sturdy surface such that the containers may easily stack on top of each other. Containers are nestable inside the edges 116, 142 such that when stacked, two containers create a smooth and continuous appearance with no gaps of space between the stacked containers. Nestability of containers create a sturdier stacking structure during shipping and storing of containers.

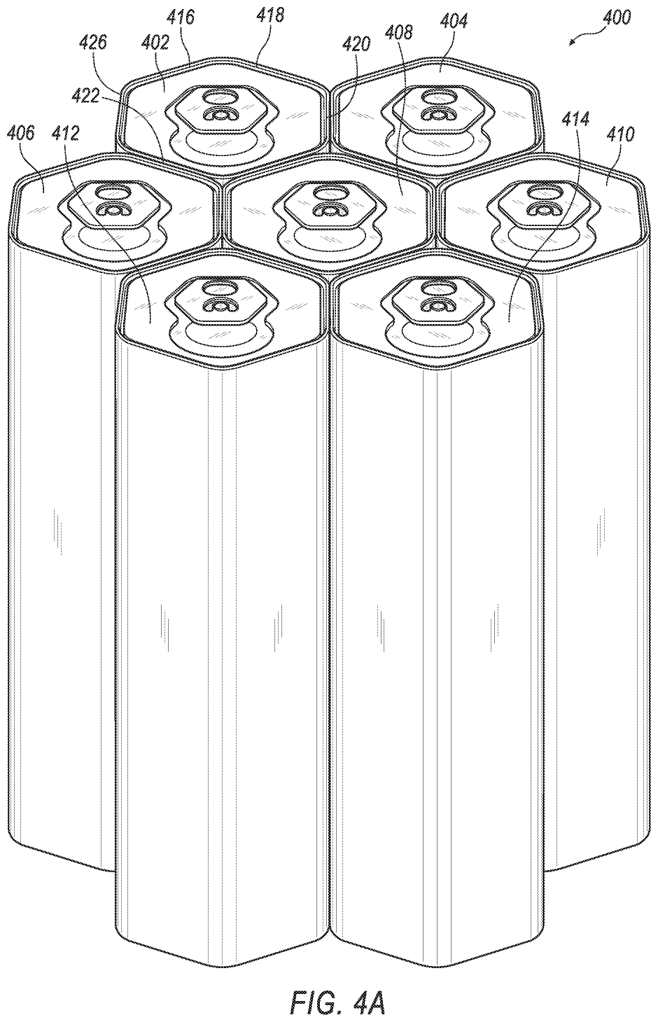

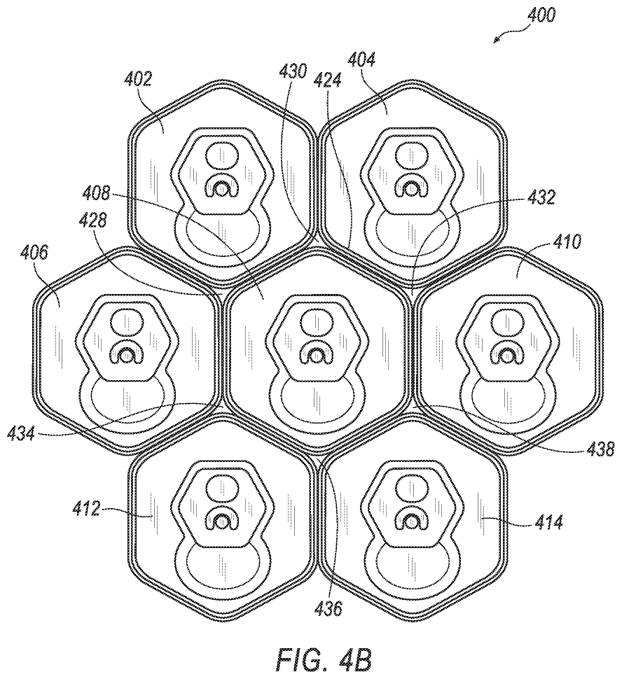

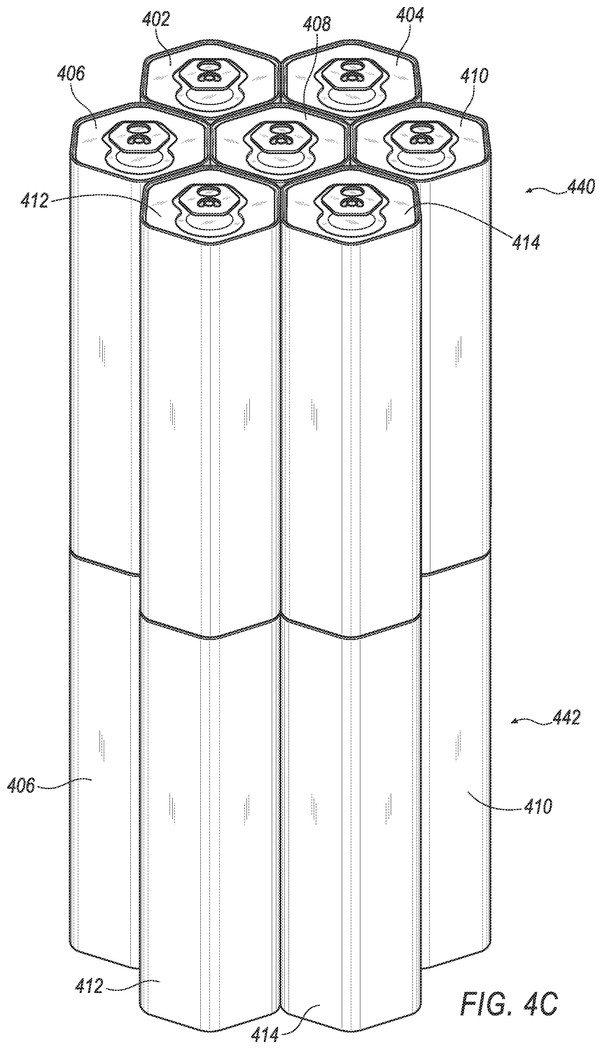

FIG. 4A illustrates an additional nested configuration 400, such that hexagon shaped containers are configured in a seven-pack shaped like a hive from a perspective view. A first container 402 is placed such that a third linear edge 420 of first container 402 is placed next to sixth linear edge 426 of second container 404 such that third edge 420 of first container 402 and sixth edge 426 of second container 404 run parallel to each other. A third container 406 is placed such that second linear edge 418 of third container 406 is placed next to fourth linear edge 422 of first container 402. A fourth container 408 is placed such that first linear edge 416 of fourth container 408 is next to fourth linear edge 422 of first container 402, second edge 418 of fourth container 408 is next to fifth edge 424 of second container 404, and sixth edge 426 of fourth container 408 is next to third edge 420 of third container 406. Fifth container 410 is placed such that first edge 416 of fifth container 410 is next to fourth edge 422 of second container 404 and sixth edge 426 of fifth container 410 is next to third edge 420 of fourth container 408. Sixth container 412 is placed such that first edge 416 of sixth container 412 is next to fourth edge 422 of third container 406 and second edge 418 of sixth container 412 is next to fifth edge 424 of fourth container 408. Seventh container 414 is placed such that first edge 416 of seventh container 414 is next to fourth edge 422 of fourth container 408, second edge 418 of seventh container 414 is next to fifth edge 424 of fifth container 410, and sixth edge 426 of seventh container 414 is next to third edge 420 of sixth container 412. Fourth container 408 is surrounded such that fourth container 408 should touch a different container of seven-pack on each edge of fourth container 408.

FIG. 4B illustrates a seven-pack of hexagon shaped containers nested in a hive shaped configuration 400 from a top view. As illustrated in 4A, and more clearly shown in 4B, hive shaped configuration of hexagon shaped containers reduces wasted space in a grouped configuration. First container 402, third container 406, and fourth container 408 converge at a corner, creating a first white space 428 of wasted area between the first container 402, third container 408, and fourth container 408. First container 402, second container 404, and fourth container 408 converge at a corner, creating a second white space 430 of wasted area between first container 402, second container 404, and fourth container 408. Second container 404, fourth container 408, and fifth container 410 converge at a corner, creating a third white space 432 of wasted area between second container 404, fourth container 408, and fifth container 410. Third container 406, fourth container 408, and sixth container 412 converge at a corner, creating a fourth white space 434 of wasted area between third container 406, fourth container 408, and sixth container 412. Fourth container 408, sixth container 412, and seventh container 414 converge at a corner, creating a fifth white area 436 of wasted space between a fourth container 408, sixth container 412, and seventh container 414. Fourth container 408, fifth container 410, and seventh container 414 converge along a corner creating a sixth white space 438 of wasted area between fourth container 408, fifth container 410, and seventh container 414. All corners on the plurality of containers are approximately 120 degrees. When three approximately 120-degree corners converge in a 360-degree space, minimal space is wasted as the corners fit together. The containers tessellate and gaps between the containers are reduced.

FIG. 4C illustrates a perspective view of hive shaped configurations stacked on top of each other. A first seven pack 440 of hexagon shaped containers nested in a hive shaped configuration is placed on top of a second seven-pack 442 of hexagon shaped containers nested in a hive shaped configuration. A first container 402 of first pack 440 is placed on top of a first container 402 of second pack 442. A second container 404 of first pack 440 is placed on top of a second container 404 of second pack 442. A third container 406 of first pack 440 is placed on top of a third container 406 of second pack 442. A fourth container 408 of first pack 440 is placed on top of a fourth container 408 of second pack 442. A fifth container 410 of first pack 440 is placed on top of a fifth container 410 of second pack 442. A sixth container 412 of first pack 440 is placed on top of a sixth container 412 of second pack 442. A seventh container 414 of first pack 440 is placed on top of a seventh container 412 of second pack 442. As illustrated in FIGS. 1B and 1C, the containers stack on top of each other such that hexagon edge 142 from the bottom 106 of a container from first pack 440 fits inside hexagon edge 116 from the top 104 of a container from the bottom pack 442. Containers from bottom pack 442 are nestable with containers from top pack 440 such that edge 142 from bottom 106 is receivable within edge 116 from top 104. Convergence of containers on top of each other creates a nearly flat, sturdy surface such that the containers may easily stack on top of each other. Containers are nestable inside the edges 116, 142 such that when stacked, two containers create a smooth and continuous appearance with no gaps of space between the stacked containers. Nestability of containers create a sturdier stacking structure during shipping and storing of containers.

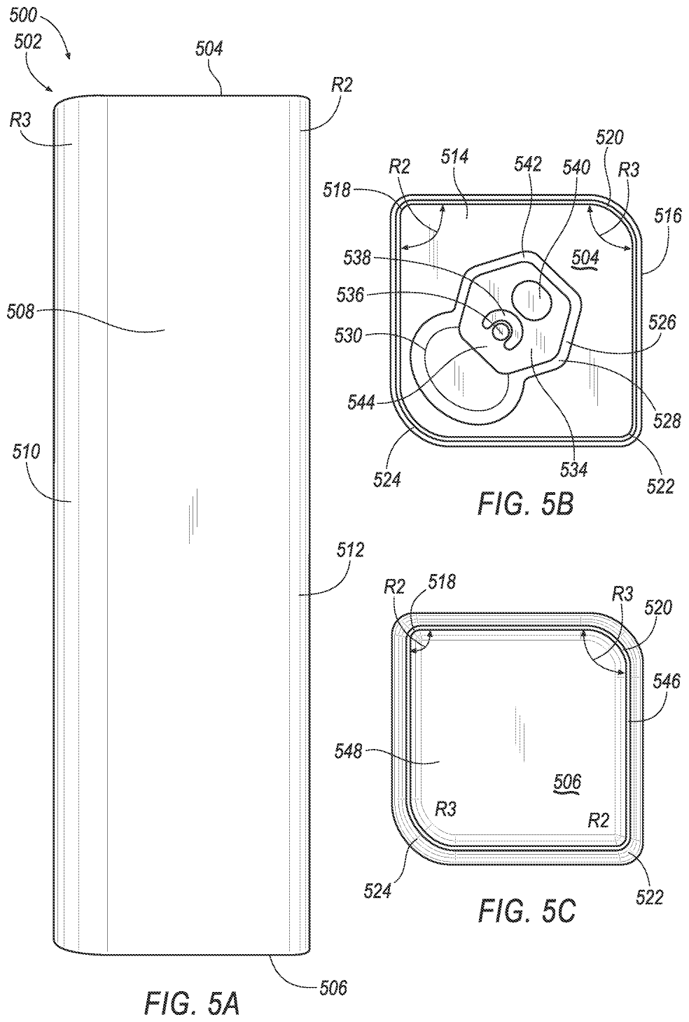

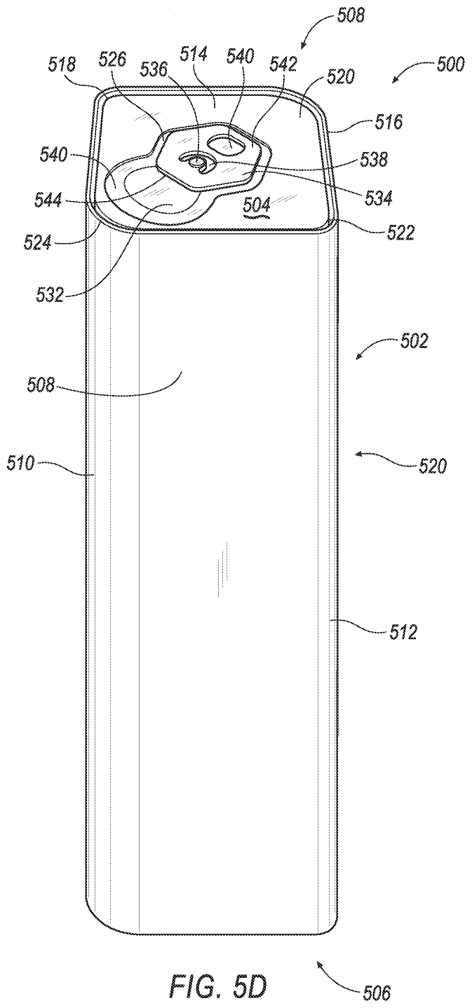

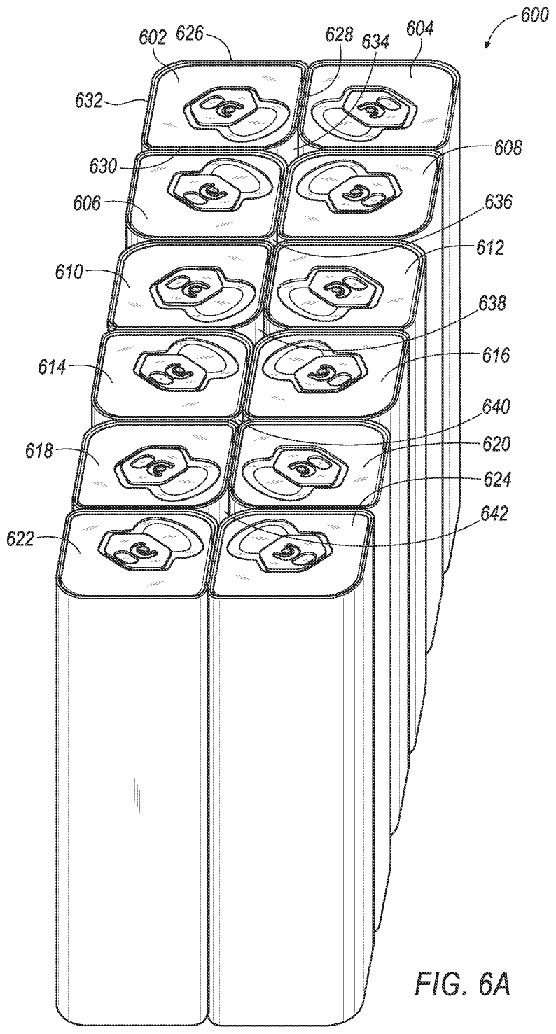

Referring to FIGS. 5A-5D, a container 500 for storing liquid, comprising a top 504, a bottom 506, and a body 502, wherein the top 504 is a first quadrilateral recessed surface 514, the first quadrilateral recessed surface 514 having two rounded corners 520, 524 and two sharp corners 518, 522, the first quadrilateral recessed surface 514 surrounded by a first raised edge 516, the first quadrilateral recessed surface 514 includes a secondary recessed surface 526 having a hexagonal pull tab 534, the hexagonal pull tab 534 configured to engage an oval punchout opening 532 to open the container 500, wherein the bottom 506 is a second quadrilateral recessed surface 548; the second quadrilateral recessed surface 548 having two rounded corners 520, 524 and two sharp corners 518, 522, the second quadrilateral recessed surface 548 having a second raised edge 546, the second raised edge 546 configured to fit inside the first raised edge 516 of the top 504, and wherein the body 502 has four sides extending vertically from the top 504 to the bottom 506; the body 502 having two round edges 510 and two sharp edges 512; and wherein at least the body 502 is comprised of biobased polymer materials made without the use of fossil fuels.

A container 500 has a quadrilateral, leaf shaped configuration that begins at top 504 and extends vertically through container 500 to bottom 506. FIG. 5A illustrates a front view of leaf shaped container 500. A first wall 508 runs vertically from top 504 of container 500 to bottom 506 of container 500. First wall 508 and body 502 of container can be any size, but preferably having a length of about 6 inches for storing liquid beverages. Width of body 102 and container 100 may be approximately forty percent of body 102 length. First wall 508 has a round edge 510 that runs the vertical length of container 500 on a first side, and a sharp edge 512 that runs the vertical length on container 500 of a second side. Round edge 510 has a corner radius R3 of approximately 0.625″. Sharp edge 512 has a corner radius R2 of approximately 0.250″. It will be appreciated that the radii may be of different values.

FIG. 5B illustrates a top view of the leaf shaped container 500. Top 504 of container 500 contains a first recessed surface 514 in a leaf shape. A raised edge 516 surrounds the perimeter of the first recessed surface 514 with four linear edges and four rounded corners with two of the corners of a first radii, and the second rounded corners of a different or second radii. Top 504 contains two rounded corners 520, 524 and two sharp corners 518, 522, such that the rounded corners 520, 522 are opposing corners on top 504 and sharp corners 518, 522 are opposing corners. Rounded corner 520, 522 have a corner radius larger than the corner radius of sharp corners 518, 522. First corner 518 and third corner 522 are sharp corners, having a corner radius R2 of approximately 0.250″. Second corner 520 and fourth corner 524 are rounded corners, having a corner radius R3 of approximately 0.625″. The offset rounded and sharp corners create a leaf shape with opposing rounded and sharp corners on top 504 of container 500 that run throughout the length of container 500 from top 504 to bottom 506. First recessed surface 514 includes a second recessed surface 526. Second recessed surface 526 is shaped as a hexagon with an oval along the bottom edge of the hexagon. Second recessed surface 526 is positioned such that hexagon portion 528 of second recessed surface 526 is angled and facing towards a fourth corner 524 of container 500 top 504. Oval portion 530 of second recessed surface 526 is proximate fourth corner 524 of container 500 top 504 and hexagon portion 528 is proximate near center of first recessed surface 514. Oval portion 530 of second recessed surface 526 includes an oval punch out opening 532. A pull tab 534 is located on top of second recessed surface 526 near the approximate center of the hexagon portion 528 of second recessed surface 526. Pull tab 534 is attached to second recessed surface 526 with a circular pin 536. Surrounding circular pin 536 is a horseshoe opening 538 pointing towards the oval portion 530 of second recessed surface 526. Pull tab 534 has an oval opening 540 positioned towards the curved portion of horseshoe opening 538.

Traditional pull tabs are made of aluminum but pull tab may be made of a variety of materials, including a biobased polymer. Illustrated in FIG. 5B is a hexagon shaped pull tab 534, but any geometric configuration may be used. Pull tab 534 is configured to be drawn up in a vertical direction by a consumer on a first side 542. Oval opening 540 on pull tab 534 is configured to be used by consumer to grip pull tab 534 with finger to assist in drawing tab up. Pull tab 534 is configured to move on a hinge line at horseshoe opening 538 such that when pull tab 534 is pulled upward on a first side 542, pull tab 534 bends and a second side 544 opposite first side 542 is pushed down in a vertical direction. Horseshoe opening 538 is configured to bend without breaking when pull tab 534 is drawn up. When first side 542 is drawn up, second side 544 pushes down on oval punch out opening 532 on second recessed surface 526 of top 504. Punch out opening 532 is illustrated as an oval, but any shape opening may be used. When second side 544 of pull tab 534 pushes down on punch out opening 532, punch out opening 532 will perforate, creating an orifice in second recessed surface 526. Orifice allows liquid to exit container 500 to be used or consumed by consumer.

FIG. 5C illustrates a bottom view of leaf shaped container 500. Bottom 506 includes four linear edges and four corners that form one continuous smooth surface for nesting with another container that may be stacked with one another. A first corner 518 and a third corner 522 are sharp corners, having a corner radius of approximately 0.250″. A second corner 520 and a fourth corner 524 are rounded corners, having a corner radius of approximately 0.625″. The offset rounded and sharp corners create a leaf shape to container 500 bottom 506 that runs throughout the length of container 500 from top 504 to bottom 506. Bottom 506 includes a raised bottom edge 546. Bottom edge 546 extends from bottom 506 of container 500 in length approximately two percent of overall length of container 500. Containers are nestable in that bottom edge 546 is configured such that if placed on top of a second leaf shaped container 500, bottom edge 546 would fit inside edge 516 of container 500 top 504. Bottom edge 546 of a first container is receivable within top edge 516 and first recessed surface 514 of a second container. Top edge 516 of second container would create an outer leaf shaped edge and bottom edge 546 of first container would create an inner leaf shaped edge. Configuration allows for containers to stack with ease of fit. Overlap on the surfaces creates a sturdier interaction between stacked containers. Containers are nestable inside the edges 516, 546 such that when stacked, two containers create a smooth and continuous appearance with no gaps of space between the stacked containers. Nestability of containers create a sturdier stacking structure during shipping and storing of containers.

FIG. 5D illustrates a perspective view of leaf shaped container 500. Container 500 includes body 502 that extends longitudinally from top 504 of container 500. First wall 508 is visible with a rounded seam 510 on a first side and a sharp seam 512 on a second side. Top 504 of container 500 is a leaf shape, with two rounded corners 520, 524 and two sharp corners 518, 522. Raised edge 516 surrounds the perimeter of the top 504 of container 500 with four edges. Inside raised edge 516 is a leaf shaped first recessed surface 514. First recessed surface 514 contains second recessed surface 526. Second recessed surface 526 is in the shape of a hexagon with an oval converging along the bottom side. Second recessed surface 526 is positioned such that the hexagon portion 528 is angled toward third corner 522 with oval portion 540 proximate the third corner 524. Second recessed surface 526 contains pull tab 534 near proximate center of hexagon portion 528 of second recessed surface 526. Pull tab 534 is illustrated as a hexagonal shape. Pull tab 534 includes an oval opening 540 for a user's finger near proximate center of hexagonal pull tab 534 and favoring a position towards a first side 542 of pull tab 534. Near proximate center of hexagonal pull tab 534 and favoring a position towards a second side 544 of pull tab 534 is horseshoe opening 538, opening away from circular opening 540. Located in the middle of horseshoe opening 538 is a circular pin 536 which connects hexagonal pull tab 534 to second recessed surface 526 of container 500 top 504.

Pull tab 534 is configured to open oval punch out opening 532 on oval portion 540 of second recessed surface 526. Punch out opening 532 in second recessed surface 526 is configured to remain closed until engaged by pull tab 534. Consumer engages pull tab 534 by pulling vertically on a first side 542 of pull tab 534. Pull tab 534 hinges at horseshoe opening 538. Horseshoe opening 538 acts as a fulcrum, causing second side 544 opposite of first side 542 on pull tab 534 to move downward and engages second recessed surface 526 at punch out opening 532. Once engaged, punch out opening 532 is pushed downward and separates from second recessed surface 526. Punch out opening 532 allows liquid to be poured or otherwise exited from container 500.

The top 504, the bottom 506, and the body 502 are of a quadrilateral geometric configuration, such that when a plurality of containers is configured in a group, four containers meet at a vertex; and the plurality of containers creates a tessellation with an area of wasted space reduced between the plurality of containers. Leaf shaped containers are capable of being nested in a group during at least shipping, storing, and selling. Leaf shaped containers allow containers to be grouped in at least a linear twelve-pack configuration. In grouping, four leaf shaped containers converge upon a vertex, creating a tessellation. Containers are configured such that wasted space between containers in a group is reduced. Reduction of wasted space is beneficial as more space is left either during shipping or storing for more containers. Shelf space at a grocery store is expensive and current container packaging is ineffective in that wasted space is abundant in packaging. Nesting of leaf shaped containers reduces wasted space, allowing more containers to be placed on a shelf in a more effective means.

FIG. 6A illustrates a nested configuration 600 of twelve leaf shaped containers in a linear group from a perspective view. First container 602 and second container 604 are placed such that a second edge 628 of first container 602 is place next to a fourth edge 632 of second container 604. A third container 606 is placed such that a first edge 626 of third container 606 is next to a third edge 630 of first container 602. A fourth container 608 is place such that a first edge 626 of fourth container 608 is next to third edge 630 of second container 604, and a fourth edge 632 of fourth container 608 is next to second edge 628 of third container 606. First container 602, second container 604, third container 606, and fourth container 608 are configured such that a rounded corner of each container converges to create a first white space 634 of wasted area between the first container 602, second container 604, third container 606, and fourth container 608. A fifth container 610 is placed such that a first edge 626 of fifth container 610 is next to third edge 630 of third container 606. A sixth container 612 is placed such that a first edge 626 of sixth container 612 is next to third edge 630 of fourth container 608 and fourth edge 632 of sixth container 612 is next to second edge 628 of fifth container 610. Third container 606, fourth container 608, fifth container 610, and sixth container 612 are configured such that a sharp corner of each container converges to create a second white space 636 of wasted area between the third container 606, fourth container 608, fifth container 610, and sixth container 612. A seventh container 614 is placed such that a first edge 626 of seventh container 614 is next to the third edge 630 of fifth container 610. An eighth container 616 is placed such that a first edge 626 of eighth container 616 is next to the third edge 630 of sixth container 612 and the fourth edge 632 of eight container 616 is next to the second edge 628 of seventh container 614. Fifth container 610, sixth container 612, seventh container 614, and eighth container 616 are configured such that a rounded corner of each container converges to create a third white space 638 of wasted area between the fifth container 610, sixth container 612, seventh container 614, and eighth container 616. A ninth container 618 is placed such that a first edge 626 of ninth container 618 is next to a third edge 630 of seventh container 614. A tenth container 620 is placed such that a first edge 626 of tenth container 620 is next to third edge 630 of eighth container 616 and fourth edge 632 of tenth container 620 is next to second edge 628 of ninth container 618. Seventh container 614, eighth container 616, ninth container 618, and tenth container 620 are configured such that a sharp corner of each container converges to create a fourth white space 640 of wasted area between seventh container 614, eighth container 616, ninth container 618, and tenth container 620. An eleventh container 622 is positioned such that a first edge 626 of eleventh container 622 is placed next to third edge 630 of ninth container 618. A twelfth container 624 is positioned such that a first edge 626 of twelfth container 624 is positioned next to third edge 630 of tenth container 620 and fourth edge 632 of twelfth container 624 is next to second edge 628 of eleventh container 622. Ninth container 618, tenth container 620, eleventh container 622, and twelfth container 624 are configured such that a rounded corner of each container converges to create a fifth white space 642 of wasted area between the ninth container 618, tenth container 620, eleventh container 622, and twelfth container 624.

FIG. 6B illustrates a nested configuration 600 of twelve leaf shaped containers in a linear group from a top view. As illustrated in FIG. 6A and more clearly shown in FIG. 6B, the nested twelve pack produces a linear arrangement. The leaf shape allows containers to be grouped in such a way to reduce space between the corners of containers compared to traditional shapes and configurations. The plurality of white spaces is made up of alternating converging corners of the leaf shaped containers. First white space 634 is created by the convergence of a rounded corner from each of first container 602, second container 604, third container 606, and fourth container 608. Second white space 636 is created by the convergence of a sharp corner from each of third container 606, fourth container 608, fifth container 610, and sixth container 612. Third white space 638 is created by the convergence of a rounded corner from each of fifth container 610, sixth container 612, seventh container 614, and eighth container 616. Fourth white space 640 is created by the convergence of a sharp corner from each of seventh container 614, eighth container 616, ninth container 618, and tenth container 620. Fifth white space 642 is created by the convergence of a rounded corner from each of ninth container 618, tenth container 620, eleventh container 622, and twelfth container 624. First white space 634, third white space 638, and fifth white space 642 are created by convergence of rounded corners and are larger is space then second white space 636 and fourth white space 640. Second white space 636 and fourth white space 640 are created by convergence sharp corners and are smaller in space then first white space 634, third white space 638, and fifth white space 642. The plurality of white spaces are smaller in size then that of traditional container shapes, resulting in less wasted space in packaging due to the tessellation of the leaf shaped containers. Reduction in wasted space between the containers allow the nested configuration of containers to take up less space, such as in locations where space is limited like on a shelf at a grocery store or while in shipping.

FIG. 6C illustrates a first linear twelve-pack 644 of leaf shaped containers stacked on top of a second linear twelve-pack 646 of leaf shaped containers. A first container 602 from a first pack 644 in stacked on top of a first container 602 from a second pack 646. A second container 604 from a first pack 644 in stacked on top of a second container 604 from a second pack 646. A third container 606 from a first pack 644 in stacked on top of a third container 606 from a second pack 646. A fourth container 608 from a first pack 644 in stacked on top of a fourth container 608 from a second pack 646. A fifth container 610 from a first pack 644 in stacked on top of a fifth container 610 from a second pack 646. A sixth container 612 from a first pack 644 in stacked on top of a sixth container 612 from a second pack 646. A seventh container 614 from a first pack 644 in stacked on top of a seventh container 614 from a second pack 646. An eight container 616 from a first pack 644 in stacked on top of an eighth container 616 from a second pack 646. A ninth container 618 from a first pack 644 in stacked on top of a ninth container 618 from a second pack 646. A tenth container 620 from a first pack 644 in stacked on top of a tenth container 620 from a second pack 646. An eleventh container 622 from a first pack 644 in stacked on top of an eleventh container 622 from a second pack 646. A twelfth container 624 from a first pack 644 in stacked on top of a twelfth container 624 from a second pack 646. As illustrated in FIGS. 5B and 5C, an edge 516 of top 504 is nestable with edge 546 of bottom 506. Bottom edge 546 of a container from second pack 646 is received within edge 516 of top 504 of a container from first pack 644 creating a nested stack. Containers are nestable inside the edges 516, 546 such that when stacked, two containers create a smooth and continuous appearance with no gaps of space between the stacked containers. Nestability of containers create a sturdier stacking structure during shipping and storing of containers.

In addition to stacked configurations, the leaf shaped containers allow nested configurations to sit adjacent to each other in such ways to reduce wasted space between nested configurations. FIG. 6D illustrates three linear twelve-packs 644, 646 and 648 configured adjacent to each other from a top view. A second twelve-pack 646 is placed directly adjacent to the first pack 644 such that the second container of the first pack 644 and the first container of the second pack 646 are next to each other. The fourth container of the first pack 644 and the third container of the second pack 646 are next to each other. The sixth container of the first pack 644 and the fifth container of the second pack 646 are next to each other. The eighth container of the first pack 644 and the seventh container of the second pack 646 are next to each other. The tenth container of the first pack 644 and the ninth container of the second pack 646 are next to each other. The twelfth container of the first pack 644 and the eleventh container of the second pack 646 are next to each other. A third twelve-pack 648 is placed directly adjacent to the second pack 646 such that such that the second container of the second pack 646 and the first container of the third pack 648 are next to each other. The fourth container of the second pack 646 and the third container of the third pack 648 are next to each other. The sixth container of the second pack 646 and the fifth container of the third pack 648 are next to each other. The eighth container of the second pack 646 and the seventh container of the third pack 648 are next to each other. The tenth container of the second pack 646 and the ninth container of the third pack 648 are next to each other. The twelfth container of the second pack 646 and the eleventh container of the third pack 648 are next to each other.

In addition to the white spaces created in a single linear twelve-pack (as shown and described in FIG. 6B), a white space of wasted area is created between the plurality of twelve-pack configurations at each location where four containers converge. White spaces 650, 652, 654, 656 and 658 are created between first pack 644 and second pack 646. Likewise, white spaces similarly are created between the second pack 646 and the third pack 648. As illustrated amongst the plurality of packs in FIG. 6D, the area of wasted space illustrated as white spaces between containers is minimal due to the tessellation of the leaf shaped containers. Linear packs of leaf shaped containers reduce wasted space on shelves and in shipping, allowing for more efficient use of space which is often limited and expensive for manufacturers to use.

In addition to being a unique shape of either a hexagon or a leaf, the liquid containers are made of biobased and biodegradable-compostable polymer materials. Consumers will be able to identify the ecological benefit of the containers based on the unique shape of the container. Biobased materials are made from sustainable materials and are substantially free of petroleum- based compounds. Therefore, they typically leave a lower CO2 footprint. They are organic polymers in which the carbon partly or fully comes from plant-biomass resources. For example, bio-based polymers may be produced from corn or sugarcane.

Biodegradable describes the ability of microbes to completely utilize the material carbon as measured by evolved carbon dioxide due to microbial metabolism. Biodegradable polymers may be degradable as a result of the action of naturally occurring microorganisms such as algae, bacteria, and fungi. Biodegradable polymers may also include compostable polymers. Compostable describes biodegradability in managed, active industrial and residential composting systems.

The biobased or biodegradable polymers used in the composition of the container may be any suitable biobased or biodegradable polymer. The biobased or biodegradable polymer may include more than one biobased or biodegradable polymer blended into the composition. Examples of biobased or biodegradable polymers which may be used are polylactic acid (PLA) or polyhydroxyalkanoates (PHAs).

Polylactic acid is a thermoplastic polyester that contains the backbone formula of (C₃H₄O₂)ₙ. Generally, it is obtained through ring-opening polymerization of a lactide or by condensation of lactic acid with loss of water. The lactic acid is produced from raw natural material such as corn starch or sugarcane, making it biobased material. PLA is degradable by at least three mechanisms including hydrolysis, thermal degradation, and photodegradation. Under industrial composting conditions, PLA starts with chemical hydrolysis, followed by microbial digestion to ultimately degrade.

Polyhydroxyalkanoates are biodegradable polymers, synthesized by soil microbes, including through bacterial fermentation of sugars and lipids. PHAs are thermoplastic and can be processed on conventional processing equipment. Over 150 different monomers can be combined with PHAs to give the compositions extremely different properties, making it possible for a wider range of applications. Examples of PHAs that could be used in the present application include PHBH (polyhydroxy butyrate hexanoate) or PHBV (polyhydroxy butyrate valerate).

In the present disclosure, the biobased polymer may be used alone or as a blend. Depending on the application, the composition of the present disclosure can be blended with a variety of other agents such as coloring agents, inorganic or organic reinforcing agents, fillers, viscosity-increasing agents, viscosity-decreasing agents, or stabilizers. Standard thermoplastic processing methods may be employed for manufacturing the container, including thermoforming or molding. The biobased and biodegradable polymers may also be used in a hybrid paper-plastic construct. Standard paper forming methods may be utilized if a blended paper-biopolymer composition is utilized.

Utilizing a combination of biobased polymer materials with a new and unique container shape, manufacturers will have an environmentally friendly container that stands out to consumers who are interested in ecofriendly goods. Manufacturers will additionally take advantage of extra shelf and storing space with unique container shapes that tessellate, leaving less wasted space than traditional containers. Stores will be able to keep more products on shelves due to the tessellation and staking capabilities of the container shapes.

According to the disclosure, a container for storing liquids or semi liquids includes a top, a bottom, and a body. The top has a first hexagonal recessed surface surrounded by a first raised edge with six equal sides, the first hexagonal recessed surface includes a secondary recessed surface having a hexagonal pull tab, the hexagonal pull tab is configured to engage an oval punchout opening to open the container. The bottom has a second hexagonal recessed surface surrounded by a second raised edge with six equal sides, the second raised edge is configured to fit inside the first raised edge of the top. The body has six sides extending vertically from the top to the bottom, and at least the body is comprised of biobased polymer materials made without the use of fossil fuels.

According to another aspect, a container for storing liquids or semi liquids includes a top, a bottom, and a body. The top is a first quadrilateral recessed surface, the first quadrilateral recessed surface having two rounded corners and two sharp corners, the first quadrilateral recessed surface is surrounded by a first raised edge, the first quadrilateral recessed surface includes a secondary recessed surface having a hexagonal pull tab, and the hexagonal pull tab is configured to engage an oval punchout opening to open the container. The bottom is a second quadrilateral recessed surface, the second quadrilateral recessed surface having two rounded corners and two sharp corners, the second quadrilateral recessed surface having a second raised edge, and the second raised edge configured to fit inside the first raised edge of the top. The body has four sides extending vertically from the top to the bottom, the body having two rounded edges and two sharp edges, and at least the body is comprised of biobased polymer materials made without the use of fossil fuels.

According to another aspect, a container for storing liquids or semi liquids includes a top, a bottom, and a body. The top is a first recessed surface surrounded by a raised edge, the first recessed surface having a secondary recessed surface with a pull tab configured to engage a punchout opening to open the container. The bottom is a second recessed surface surrounded by a second raised edge, and the second raised edge configured to fit inside the first raised edge of the top. The body is a polygon with at least four sides extending vertically from the top to the bottom and at least the body is comprised of biobased polymer materials.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the preceding discussion is generally provided in the context of a container for storing beverages it should be appreciated that the present techniques are not limited to such liquids for consumption. The provision of examples and explanations in such a container is to facilitate explanation by providing instances of implementations and applications. The disclosed approaches may also be utilized in other contexts, such as storing not for consumption liquids or for containing solids.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

1. A container for storing liquids, comprising:
a top, a bottom, and a body;
wherein the top has a first hexagonal recessed surface surrounded by a first raised edge with six equal sides; the first hexagonal recessed surface includes a secondary recessed surface having a hexagonal pull tab; the hexagonal pull tab configured to engage an oval punchout opening to open the container;
wherein the bottom has a second hexagonal recessed surface surrounded by a second raised edge with six equal sides; the second raised edge configured to fit inside the first raised edge of the top; and
wherein the body has six sides extending vertically from the top to bottom; and
wherein at least the body is comprised of biobased polymer materials made without the use of fossil fuels.

2. The container of claim 1, wherein the top, the bottom, and the pull tab are made of biobased polymer materials.

3. The container of claim 1, wherein at least the body is comprised of polylactic acid.

4. The container in claim 1, wherein at least the body is comprised of polyhydroxyalkanoates.

5. The container of claim 1, wherein at least the body is comprised of compostable materials.

6. The container of claim 1, wherein the bottom is configured such that the second raised edge of the bottom can fit inside the first raised edge of the top of a second container, such that a plurality of containers may be stacked vertically on one another.

7. The container of claim 1, wherein the top, the bottom, and the body are of a hexagonal geometric configuration; a plurality of containers is configured in a group such that three containers meet at a vertex; and the plurality of containers creates a tessellation with an area of wasted space reduced between the plurality of containers.

8. A container for storing liquid, comprising:
a top, a bottom, and a body;
wherein the top is first quadrilateral recessed surface; the first quadrilateral recessed surface having two rounded corners and two sharp corners; the first quadrilateral recessed surface surrounded by a first raised edge; the first quadrilateral recessed surface includes a secondary recessed surface having a hexagonal pull tab; the hexagonal pull tab configured to engage an oval punchout opening to open the container;
wherein the bottom is a second quadrilateral recessed surface; the second quadrilateral recessed surface having two rounded corners and two sharp corners; the second quadrilateral recessed surface having a second raised edge; the second raised edge configured to fit inside the first raised edge of the top; and
wherein the body has four sides extending vertically from the top to the bottom; the body having two rounded edges and two sharp edges; and
wherein at least the body is comprised of biobased polymer materials made without the use of fossil fuels.

9. The container of claim 8, wherein the top, the bottom, and the pull tab are made of biobased polymer materials.

10. The container of claim 8, wherein the rounded corners are opposing corners and have a corner radius larger than the corner radius of the sharp corners.

11. The container of claim 8, wherein the biobased polymer materials are compostable materials.

12. The container of claim 8, wherein the bottom is configured such that the second raised edge of the bottom fits inside the first raised edge of the top of a second container; a plurality of containers may be stacked vertically on one another; and when a container is stacked on top of a second container, the body of the first container and the body of the second container create a smooth and continuous surface such that there is no wasted space between the bodies of the containers.

13. The container of claim 8, wherein the top, the bottom, and the body of a quadrilateral geometric configuration; such that a plurality of containers may be configured in a group where four containers converge at an area of white space; and the plurality of containers creates a tessellation with an area of white space reduced between the plurality of containers.

14. A container for storing liquid, comprising:
a top, a bottom, and a body;
wherein the top is a first recessed surface surrounded by a raised edge; the first recessed surface having a secondary recessed surface with a pull tab configured to engage a punchout opening to open the container;
wherein the bottom is a second recessed surface surrounded by a second raised edge; the second raised edge configured to fit inside the first raised edge of the top;
wherein the body is a polygon with at least four sides extending vertically from the top to the bottom; and
wherein at least the body is comprised of biobased polymer materials.

15. The container of claim 14, wherein the top includes six angled corners; the six angled corners having a corner radius being equal.

16. The container of claim 14, wherein the corner radius extends from the six angled corners throughout the body of the container, such that the body contains six walls that coverage along corners with a corner radius equal to the corner radius of the top angled corners.

17. The container of claim 14, wherein the top includes four angled corners; a first corner and an opposing corner having an equal corner radius; a second corner and an opposing corner having an equal corner radius; the first corner having a corner radius larger than a corner radius of the second corner.

18. The container of claim 14, wherein the corner radius extends from the top of the container through the body of the container, such that the body container four walls that converge along corners with a first corner and a opposing corner having a equal corner radius, and a second corner and a opposing corner having a equal corner radius; the first corner having a corner radius larger than a corner radius of the second corner.

19. The container of claim 14, wherein the bottom is configured such that the second raised edge of the bottom is nestable inside the first raised edge of the top of a second container, such that a plurality of containers may be stacked vertically on one another and the body of the first container and the body of the second container create a continuous surface when stacked on one another.

20. The container of claim 14, wherein the top, the bottom, and the body are of a geometric configuration with at least four sides; a plurality of containers is configured in a group; and the plurality of containers creates a tessellation with an area of wasted spaced reduced between the plurality of containers.
